(19) United States
(12) Patent Application Publication
(10) Pub. No.: US 2015/0219318 A1
(43) Pub. Date: Aug. 6, 2015

(54) SHEET FIXING MEMBER, BACKLIGHT ASSEMBLY HAVING THE SAME AND DISPLAY APPARATUS HAVING THE SAME

(71) Applicant: Samsung Display Co., Ltd., Yongin-city (KR)

(72) Inventors: Kyung-Hoon CHAE, Cheonan-si (KR); Jae-Min SONG, Seoul (KR)

(21) Appl. No.: 14/451,618

(22) Filed: Aug. 5, 2014

(30) Foreign Application Priority Data
Feb. 3, 2014 (KR) 10-2014-0011960

(51) Int. Cl. F21V 17/08; G02F 1/1333

(52) U.S. Cl. CPC F21V 17/08; G02F 1/133308

(57) ABSTRACT

A sheet fixing member including: a body extended substantially parallel with the sidewall; a horizontal protrusion protruded from a side of the body configured to be inserted into the horizontal supporting recess; a vertical leg disposed at each side of a lower surface of the body to extend in a downward direction, the vertical legs and the body forming a sheet receiving space therebetween; and a sheet fixing protrusion protruded from a center of the lower surface of the body in the downward direction, the sheet fixing protrusion configured to be passed through the optical sheet disposed in the sheet receiving space and to be inserted into the fixing hole, wherein the sheet fixing member is configured to be combined with a mold frame to affix an optical sheet.

### PRIORITY STATEMENT

This application claims priority from and the benefit of Korean Patent Application No. 10-2014-0011960, filed on Feb. 3, 2014, which is hereby incorporated by reference for all purposes as if fully set forth herein.

### BACKGROUND

1. Field

The exemplary embodiments of present inventive concept relate to a sheet fixing member, a backlight assembly having the same and a display apparatus having the same. More particularly, the exemplary embodiments of present inventive concept relate to a sheet fixing member capable of decreasing defects to the display and being easily fabricated, a backlight assembly having the same and a display apparatus having the same.

2. Discussion of the Background

Display apparatuses include an active-type display apparatus and a passive-type display apparatus. The active-type display apparatus displays an image using an active element that generates light. The passive-type display apparatus controls transmittance of light generated from a light source to display an image.

The passive-type display apparatus includes a display panel and a backlight assembly supplying light to the display panel. The display panel includes a light crystal element, an electrophoretic element, etc.

The backlight assembly includes the light source generating the light, an optical sheet improving light characteristics of the light generated from the light source, etc.

When the size of the display panel is increased, the size of the optical sheet is also increased. The optical sheet is thin and may be easily deformed by an external force. Also, when the optical sheet is not securely affixed, the optical sheet may be easily dislocated from a correct position by the external impact or force.

Affixing the optical sheet using a tape, an adhesive, etc., may make manufacturing process complex and the display apparatus may not be easily fabricated.

The above information disclosed in this Background section is only for enhancement of understanding of the background of the invention and therefore it may contain information that does not form any part of the prior art nor what the prior art may suggest to a person of ordinary skill in the art.

### SUMMARY

Exemplary embodiments of the present invention provide a sheet fixing member capable of decreasing defect to the display and capable of being easily fabricated.

Exemplary embodiments of the present invention provide a backlight assembly including the above-mentioned sheet fixing member.

Exemplary embodiments of the present invention also provide a display apparatus including the above-mentioned sheet fixing member.

Additional features of the invention will be set forth in the description which follows, and in part will be apparent from the description, or may be learned by practice of the invention.

An exemplary embodiment of the present invention provides a sheet fixing member including: a body extended substantially parallel with the sidewall; a horizontal protrusion protruded from a side of the body configured to be inserted into the horizontal supporting recess; a vertical leg disposed at each side of a lower surface of the body to extend in a downward direction, the vertical legs and the body forming a sheet receiving space therebetween; and a sheet fixing protrusion protruded from a center of the lower surface of the body in the downward direction, the sheet fixing protrusion configured to be passed through the optical sheet disposed in the sheet receiving space and to be inserted into the fixing hole, wherein the sheet fixing member is configured to be combined with a sheet fixing recess formed on a sidewall of a mold frame to affix an optical sheet, the sheet fixing recess including a horizontal supporting recess extended substantially parallel with the sidewall and a fixing hole formed substantially perpendicular to the sidewall.

An exemplary embodiment of the present invention provides a backlight assembly, including a light source member configured to generate light, a bottom chassis configured to affix the light source member, a mold frame is disposed on the bottom chassis, the mold frame including a sheet fixing recess formed on a sidewall of the mold frame, an optical sheet including a sheet body and a fixing portion being protruded from a side of the sheet body aligned to the sheet fixing recess, wherein the optical sheet is disposed on the mold frame, and a sheet fixing member is combined with the sheet fixing recess, the sheet fixing member including a body extending substantially parallel with the sidewall, a vertical leg disposed at each side of a lower surface of the body to extend in a downward direction, the vertical legs and the body forming a sheet receiving space therebetween, in which the fixing portion is received, and a sheet fixing protrusion is protruded from a center of the lower surface of the body in the downward direction. The sheet fixing protrusion configured to be passed through the fixing portion of the optical sheet and to be inserted into a fixing hole formed in the fixing recess.

An exemplary embodiment of the present invention provides a backlight assembly, including a light source member configured to generate light, a bottom chassis configured to affix the light source member, a mold frame disposed on the bottom chassis, the mold frame including a sheet fixing recess formed on a sidewall of the mold frame, an optical sheet including a sheet body and a fixing portion being protruded from a side of the sheet body aligned to the sheet fixing recess, wherein the optical sheet is disposed on the mold frame, and a sheet fixing member combined with the sheet fixing recess, the sheet fixing member including a body extending substantially parallel with the sidewall, a vertical leg disposed at each side of a lower surface of the body to extend in a downward direction, the vertical legs and the body forming a sheet receiving space therebetween, in which the fixing portion is received, and a sheet fixing protrusion protruded from a center of the lower surface of the body in the downward direction, the sheet fixing protrusion configured to be passed through the fixing portion of the optical sheet and to be inserted into a fixing hole of the fixing recess.

An exemplary embodiment of the present invention provides a display apparatus, including a backlight assembly including a light source member configured to generate light, a bottom chassis configured to affix the light source member, a mold frame disposed on the bottom chassis, the mold frame including a sheet fixing recess formed on a sidewall of the mold frame, an optical sheet including a sheet body and a fixing portion being protruded from a side of the sheet body aligned to the sheet fixing recess, wherein the optical sheet is disposed on the mold frame, and a sheet fixing member combined with the sheet fixing recess, including a body is extending substantially parallel with the sidewall, a vertical leg disposed at each side of a lower surface of the body to extend in a downward direction, the vertical legs and the body forming a sheet receiving space therebetween, in which the fixing portion is received, and a sheet fixing protrusion is protruded from a center of the lower surface of the body in the downward direction, the sheet fixing protrusion configured to be passed through the fixing portion of the optical sheet and to be inserted into a fixing hole formed in the fixing recess, a display panel disposed on the backlight assembly to display an image using the light from the light source member, and a top chassis disposed on the display panel to affix the display panel to the backlight assembly.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

The above and other features and advantages will become more apparent by describing exemplary embodiments thereof with reference to the accompanying drawings, in which:

FIG. 1 is an exploded perspective view illustrating a display apparatus according to an exemplary embodiment of the present inventive concept.

FIG. 2 is a perspective view illustrating a sheet fixing member of FIG. 1.

FIG. 3 is a perspective view illustrating a sheet fixing recess of FIG. 1.

FIG. 4 is a perspective view illustrating the combination of the sheet fixing member and the sheet fixing recess of FIG. 1.

FIG. 5 is a cross-sectional view taken along a line I-I′ of FIG. 4.

FIG. 6 is an exploded perspective view illustrating a display apparatus according to an exemplary embodiment of the present inventive concept.

FIG. 7 is a sheet fixing member of FIG. 6.

FIG. 8 is a perspective view illustrating a sheet fixing recess of FIG. 6.

FIG. 9 is a cross-sectional view illustrating the combination of the sheet fixing member and the sheet fixing recess of FIG. 6.

FIG. 10 is a perspective view illustrating a sheet fixing recess according to an exemplary embodiment of the present inventive concept.

FIG. 11 is an exploded perspective view illustrating a display apparatus according to an exemplary embodiment of the present inventive concept.

FIG. 12 is a perspective view illustrating a sheet fixing member of FIG. 11.

FIG. 13 is a perspective view illustrating a sheet fixing recess of FIG. 11.

FIG. 14 is a perspective view illustrating the combination between the sheet fixing member and the sheet fixing recess of FIG. 11.

FIG. 15 is a cross-sectional view taken along a line II-IF of FIG. 14.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element or layer is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

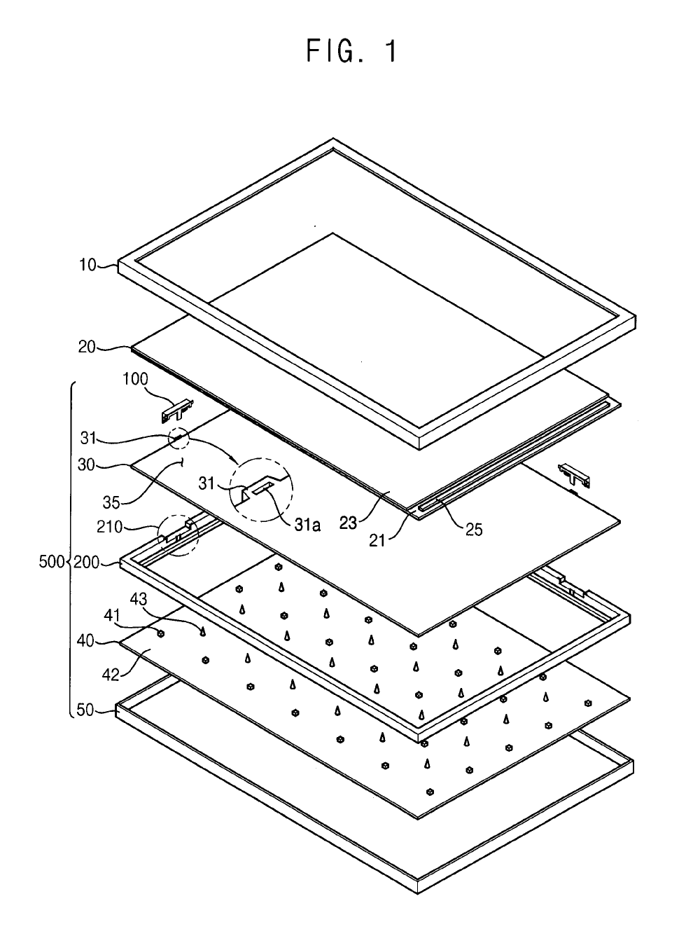

FIG. 1 is an exploded perspective view illustrating a display apparatus according to an exemplary embodiment of the present inventive concept.

Referring to FIG. 1, the display apparatus includes a display panel 20 and a backlight assembly 500. In the exemplary embodiment, the display apparatus may further include a top chassis 10.

The display panel 20 includes a first substrate 21, a second substrate 23 and a driving circuit 25. In the exemplary embodiment, the display panel may further include a light controlling layer that is disposed between the first substrate 21 and the second substrate 23 to control transmittance of light.

The display panel 20 displays an image using the light supplied from the backlight assembly 500. For example, the display panel 20 may include a liquid crystal element, an electrophoretic element, etc. When the display panel 20 includes the liquid crystal element, a liquid crystal layer may be interposed between the first substrate 21 and the second substrate 23. The first substrate 21 and the second substrate 23 may apply an electric field to the liquid crystal layer (not shown) to control the light transmittance.

The display panel 20 may further include a phase delay film, a window, a polarizing film, etc.

The backlight assembly 500 is disposed under the display panel 20 to supply the light to the display panel 20.

The backlight assembly 500 includes a sheet fixing member 100, an optical sheet 30, a mold frame 200, a light source member 40 and a bottom chassis 50.

The bottom chassis 50 includes a bottom plate having a substantially rectangular shape and a plurality of sidewalls protruded from sides of the bottom plate. The bottom chassis 50 may include a solid material such as metal, synthetic resin, etc., to protect the light source member 40 from an external impact or force.

The light source member 40 is disposed in the bottom chassis 50 to generate the light.

The light source member 40 includes a light source substrate 42 and a plurality of light sources 41 disposed on the light source substrate 42. For example, the light sources 41 may include light emitting diodes (LEDs), cold cathode fluorescent lamps (CCFLs), etc. The light sources 41 include the light emitting diodes (LEDs). For example, the light emitting diodes (LEDs) may be individually operated based on an image signal that is applied to the display panel 20.

The light source 41 is disposed on the light source substrate 42. For example, the light source 41 may be arranged on the light source substrate 42 in a matrix.

For example, a reflecting member may be disposed between the light source member 40 and the bottom chassis 50 or on an upper surface of the light source substrate 42. The reflecting member may guide the light generated from the light source 41 toward the display panel 20, thereby increasing luminance of the display apparatus.

The light source member 40 includes a plurality of sheet supporting parts 43 disposed on the light source substrate 42 to support the optical sheet 30. When the size of the optical sheet 30 is increased, a central portion of the optical sheet 30 may sag down towards the light source member 40 from a gravitational force. The sheet supporting part 43 supports the central portion of the optical sheet 30 to prevent the sagging of the optical sheet 30.

The sheet supporting parts 43 may have various shapes such as a cone shape, a pillar shape, a fork shape, etc. The sheet supporting parts 43 may have the cone shape.

The sheet supporting parts 43 may include a transparent material, a translucent material, a white material, a silver material, etc., so that the sheet supporting parts 43 do not absorb the light generated from the light source 41. When the sheet supporting parts 43 absorb the light generated from the light source 41, the luminance of the display apparatus may be decreased. The sheet supporting parts 43 do not absorb the light generated from the light source 41, so that the luminance of the display apparatus may not be decreased.

The mold frame 200 is combined with the bottom chassis 50 to receive the light source member 40. The mold frame 200 has a rectangular frame shape having an empty center. The mold frame 200 includes a synthetic resin. For example, the mold frame 200 may be combined with an outer surface of the bottom chassis 50.

A plurality of sheet fixing recesses 210 is formed on a side surface of the mold frame 200. The sheet fixing recesses 210 are formed only on two adjacent sidewalls among the four sidewalls of the mold frame 200. For example, the sheet fixing recesses 210 are formed only on an upper sidewall and a left sidewall of the mold frame 200. The sheet fixing recesses 210 formed on the upper sidewall of the mold frame 200 are configured to affix the optical sheet 30 in a vertical direction, and the sheet fixing recesses 210 formed on the left sidewall of the mold frame 200 are configured to affix the optical sheet 30 in a horizontal direction. Alternatively, the sheet fixing recesses 210 may only be formed on one or more than three sidewalls of the mold frame 200.

The optical sheet 30 is disposed on the mold frame 200 to increase the uniformity of luminance of the light generated from the light source member 40. For example, the optical sheet 30 may be a prism sheet, a diffusion sheet, etc. The optical sheet 30 may be combined with another optical sheet to form an optical film assembly.

The optical sheet 30 includes a sheet body 35 and a plurality of fixing portions 31 protruded from a side of the sheet body 35. The fixing portions 31 correspond to the sheet fixing recesses 210, respectively. Each of the fixing portions 31 includes a through hole 31a.

The sheet fixing member 100 is combined with the sheet fixing recess 210 of the mold frame 200 to affix the fixing portion 31 of the optical sheet 30.

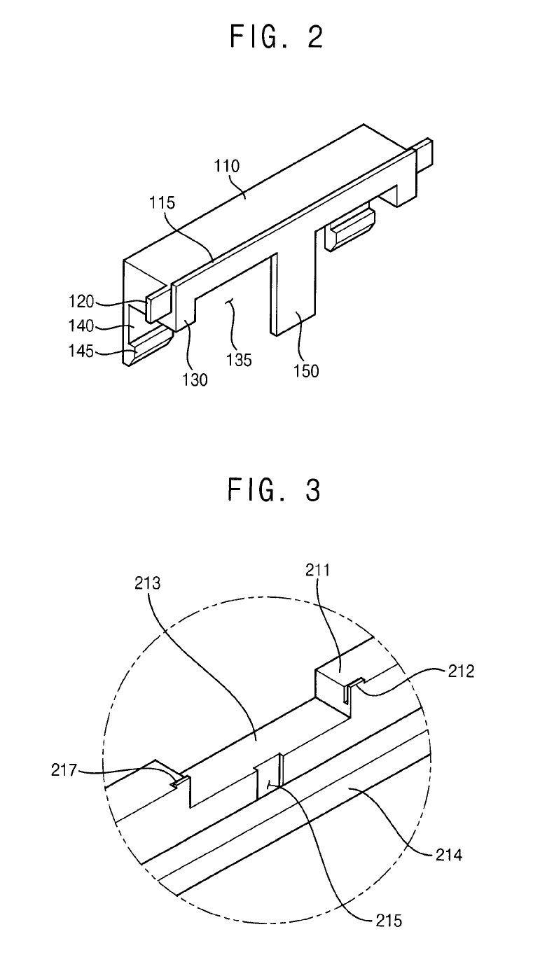

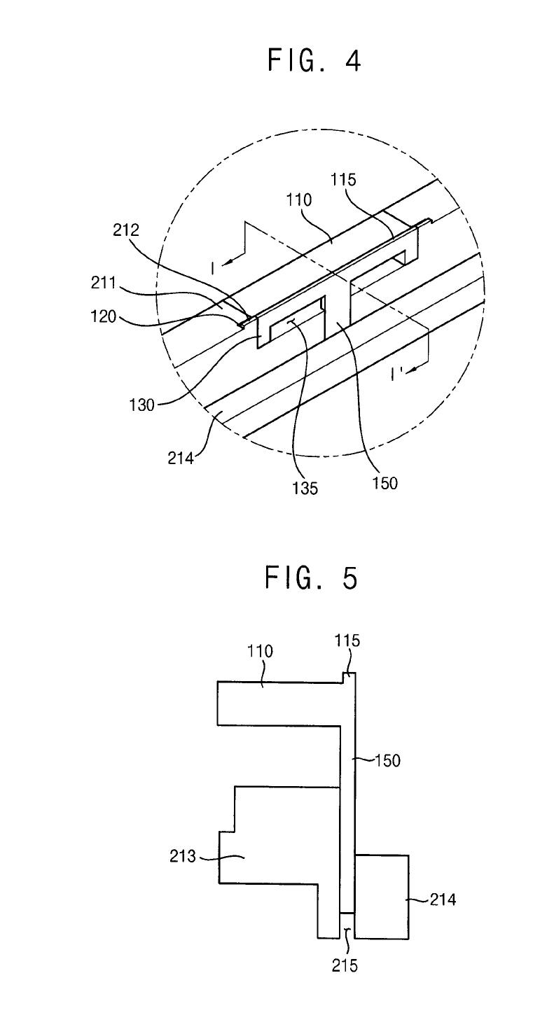

FIG. 2 is a perspective view illustrating a sheet fixing member of FIG. 1. FIG. 3 is a perspective view illustrating a sheet fixing recess of FIG. 1. FIG. 4 is a perspective view illustrating the combination of the sheet fixing member and the sheet fixing recess of FIG. 1. FIG. 5 is a cross-sectional view taken along a line I-I′ of FIG. 4.

Referring to FIGS. 1, 2, 3, 4, and 5, the sheet fixing member 100 includes a body 110, a horizontal protrusion 120, a vertical leg 130, a vertical protrusion 140 and a sheet fixing protrusion 150.

The body 110 is extended in a direction substantially parallel with the sidewall of the mold frame 200. An upper protrusion 115 is formed on the body 110 to block external impurities from flowing into the optical sheet 30.

The upper protrusion 115 of the sheet fixing member 100 has substantially the same height as the upper protrusion 212 of the mold frame 200. For example, the upper protrusions 115 and 212 make contact with an inner surface of the top chassis 10.

The horizontal protrusion 120 is protruded from the side surface of the body 110 to be inserted into a horizontal supporting recess 217 of the sheet fixing recess 210. The horizontal protrusion 120 has a substantially planar shape. For example, the horizontal protrusion 120 may have a rectangular plate shape. The horizontal protrusion 120 may also have various shapes such as a cylindrical shape, a wedge shape, etc.

The vertical leg 130 is protruded from both sides of a lower surface of the body 110 in a downward direction to form a sheet receiving space 135 in between the vertical legs 130 and the body 110. The sheet receiving space 135 receives the fixing portion 31 of the optical sheet 30.

The vertical protrusion 140 is protruded from the lower surface of the vertical leg 130 in the downward direction and is arranged along an outer surface of the sheet fixing recess 210. A first hook 145 is formed at a lower portion of the vertical protrusion 140 to be combined with the sheet fixing recess 210.

The sheet fixing protrusion 150 is protruded from a central portion of a lower surface of the body 110 to be passed through the through hole 31a of the fixing portion 31 of the optical sheet 30 and to be inserted into the fixing hole 215. The fixing hole 215 is formed between the rear supporting portion 213 and the front supporting portion 214. The front supporting portion 214 may have a height lower than that of the rear supporting portion 213. The front supporting portion 214 may also have substantially the same height as the rear supporting portion 213.

The sheet fixing member 100 includes two vertical protrusions 140 disposed along an outer surface of the sheet fixing recess 210. However, the number of the vertical protrusions 140 is not limited thereto and may be changed, for example, to be 1 or 3 or 4 vertical protrusions 140.

The sheet fixing member 100 includes a solid material such as synthetic resin, metal, etc.

Therefore, assembly of the backlight assembly 500 may be completed.

Referring back to FIG. 1, the display panel 20 is disposed on the backlight assembly 500. More specifically, the display panel 20 may be disposed on the mold frame 200 combined with the optical sheet 30 and the sheet fixing member 100.

The top chassis 10 is combined with the backlight assembly 500 to affix the display panel 20. The top chassis 10 has a rectangular frame shape having an empty center.

For example, the inner surface of the top chassis 10 may be combined with an outer surface of the mold frame 200. A screw may be fastened through the top chassis 10, the mold frame 200 and the bottom chassis 50, in sequence, to affix the top chassis 10, the mold frame 200 and the bottom chassis 50. The top chassis 10, the mold frame 200 and the bottom chassis 50 may also be combined with each other by various combination methods such as a hook combination, a tape combination, an adhesiveness combination, a fitting combination, etc.

Referring to FIGS. 1, 2, 3, 4, and 5, a method of fabricating the display apparatus of the exemplary embodiment will be explained as follows.

The bottom chassis 50 is disposed with its sidewalls aligned upward.

The light source member 40 is disposed in the bottom chassis 50. The light source member 40 includes the light sources 41 and the sheet supporting parts 43 on the light source substrate 42. The light source substrate 42 may include only the light sources 41, and the sheet supporting parts 43 may be disposed between the light source substrate 42 and the optical sheet 30 and may be disposed or formed on the optical sheet 30.

The mold frame 200 is assembled with the bottom chassis 50. The inner surface of the mold frame 200 may be fitted over the outer surface of the bottom chassis 50. The sidewall of the mold frame 200 may also have a double layered sidewall structure, and the bottom chassis 50 may be inserted between the double layered sidewalls.

The optical sheet 30 is disposed on the mold frame 200 with the fixing portion 31 disposed in the sheet fixing recess 210 of the mold frame 200. The optical sheet 30 may be supported by the sheet supporting parts 43.

The sheet fixing member 100 may be assembled with the sheet fixing recess 210 to affix the optical sheet 30 with the mold frame 200. The horizontal protrusion 120 of the sheet fixing member 100 is inserted into the horizontal supporting recess 217 of the sheet fixing recess 210, and the vertical protrusion 140 is combined along the outer surface of the rear supporting portion 213 of the sheet fixing recess 210. The first hook 145 formed under the vertical protrusion 140 is hooked under the outer surface of the rear supporting portion 213. The sheet fixing protrusion 150 may be passed through the fixing hole 31a of the fixing portion 31 of the optical sheet 30 and be inserted into the fixing recess of the sheet fixing recess 210.

Therefore, assembly of the backlight assembly 500 may be completed.

The display panel 20 is disposed on the mold frame 200 of the backlight assembly 500.

The top chassis 10 is disposed on the backlight assembly 500 on which the display panel 20 is disposed. The inner surface of the top chassis 10 may surround the outer surface of the mold frame 200 to affix the mold frame 200.

For example, the screw may be fastened through the top chassis 10, the mold frame 200 and the bottom chassis 50 from the side of the top chassis 10 so that the top chassis 10, the mold frame 200 and the bottom chassis 50 may be assembled.

According to the exemplary embodiment, the sheet fixing member 100 includes the sheet fixing protrusion 150 that is configured to be passed through the optical sheet 30 and to be assembled with the mold frame 300. Thus, the optical sheet 20 may be securely assembled with the mold frame 200 without using fixing tape. Thus, the manufacturing process may be simplified and the manufacturing cost may be decreased.

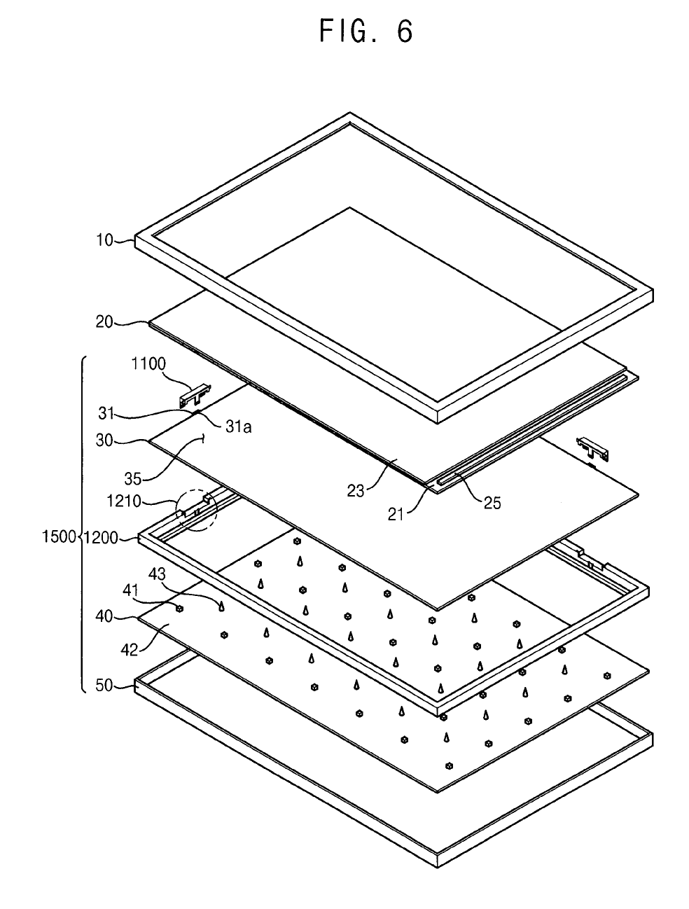

FIG. 6 is an exploded perspective view illustrating a display apparatus according to an exemplary embodiment of the present inventive concept. The display apparatus of FIG. 6 is substantially the same as the display apparatus of FIGS. 1, 2, 3, 4, and 5 except the sheet fixing member 1100 and the sheet fixing recess 1210. Thus, any further repetitive explanation concerning the same elements will be omitted.

Referring to FIG. 6, the display apparatus includes a display panel 20 and a backlight assembly 1500. The display apparatus may further include a top chassis 10.

The backlight assembly 1500 includes a sheet fixing member 1100, an optical sheet 30, a mold frame 1200, a light source member 40 and a bottom chassis 50.

The mold frame 1200 is combined with the bottom chassis 50 to receive the light source member 40.

A plurality of sheet fixing recesses 1210 is formed on a side surface of the mold frame 1200.

The optical sheet 30 is disposed on the mold frame 1200 to increase the uniformity of luminance of the light generated from the light source member 40. For example, the optical sheet 30 may be a prism sheet, a diffusion sheet, etc. The optical sheet 30 may be combined with another optical sheet to form an optical film assembly.

The optical sheet 30 includes a sheet body 35 and a plurality of fixing portions 31 protruded from a side of the sheet body 35. The fixing portions 31 correspond to the sheet fixing recesses 1210, respectively. Each of the fixing portions 31 includes a throughhole 31a.

The sheet fixing member 1100 is combined with the sheet fixing recess 1210 of the mold frame 1200 to affix the fixing portion 31 of the optical sheet 30.

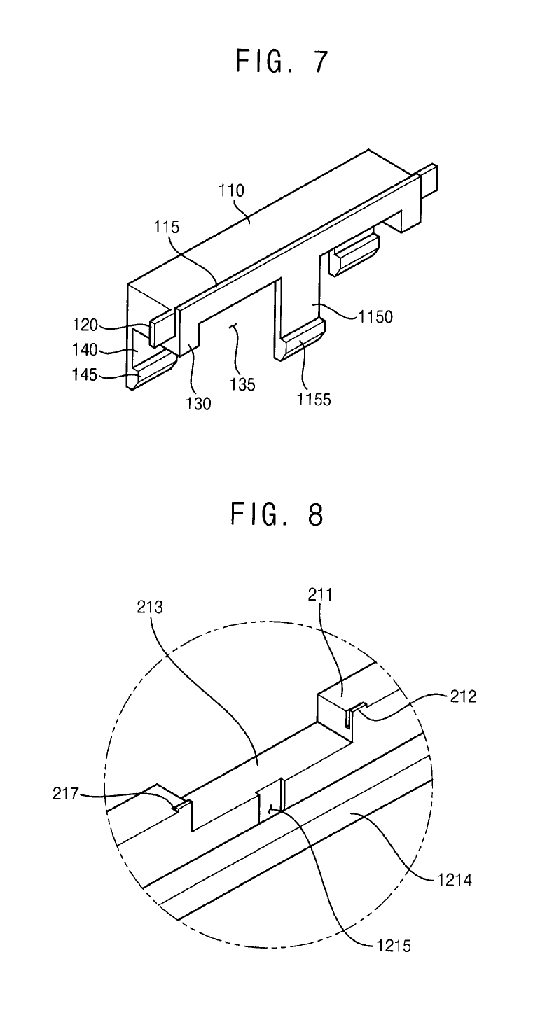

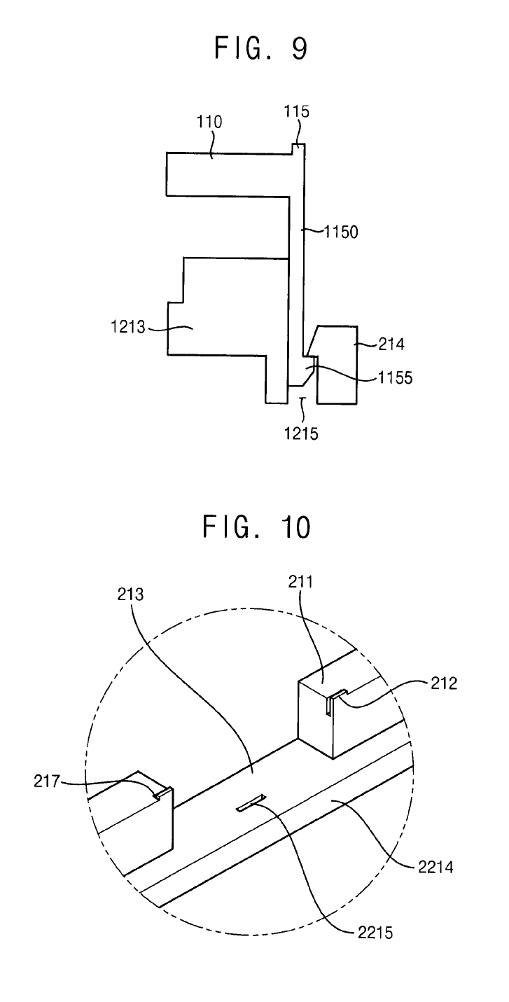

FIG. 7 is a perspective view illustrating a sheet fixing member 1100 of FIG. 6. FIG. 8 is a perspective view illustrating a sheet fixing recess 1210 of FIG. 6. FIG. 9 is a cross-sectional view illustrating the combination of the sheet fixing member 1100 and the sheet fixing recess 1210 of FIG. 6.

Referring to FIGS. 7, 8, and 9, the sheet fixing member 1100 includes a body 110, a horizontal protrusion 120, a vertical leg 130, a vertical protrusion 140 and a sheet fixing protrusion 1150.

The sheet fixing protrusion 1150 is protruded from a central portion of a lower surface of the body 110 to be passed through the through hole 31a of the fixing portion 31 of the optical sheet 30 and to be inserted into the fixing hole 1215 of the sheet fixing recess 1210. The fixing hole 1215 is formed between the rear supporting portion 213 and the front supporting portion 1214.

A second hook 1155 is formed under the sheet fixing protrusion 1150. The second hook 1155 is inserted into the fixing hole 1215 of the sheet fixing recess 1210, and is hooked on the front supporting portion 1214.

Therefore, assembly of the backlight assembly 500 may be completed.

Referring back to FIG. 6, the display panel 20 is disposed on the backlight assembly 1500. More specifically, the display panel 20 may be disposed on the mold frame 1200 combined with the optical sheet 30 and the sheet fixing member 1100.

The top chassis 10 is combined with the backlight assembly 1500 to affix the display panel 20.

Referring to FIGS. 6, 7, 8, and 9, a method of fabricating the display apparatus of the exemplary embodiment will be explained as follows.

The bottom chassis 50 is disposed with its sidewalls aligned upward.

The light source member 40 is disposed in the bottom chassis 50.

The mold frame 1200 is assembled with the bottom chassis 50. The inner surface of the mold frame 1200 may befitted over the outer surface of the bottom chassis 50.

The optical sheet 30 is disposed on the mold frame 1200 with the fixing portion 31 disposed in the sheet fixing recess 1210 of the mold frame 1200.

The sheet fixing member 1100 may be assembled with the sheet fixing recess 1210 to affix the optical sheet 30 with the mold frame 1200. The horizontal protrusion 120 of the sheet fixing member 1100 is inserted into the horizontal supporting recess 217 of the sheet fixing recess 1210, and the vertical protrusion 140 is combined along the outer surface of the rear supporting portion 213 of the sheet fixing recess 1210. The first hook 145 formed under the vertical protrusion 140 is hooked under the outer surface of the rear supporting portion 213.

The sheet fixing protrusion 1150 may be passed through the fixing hole 31a of the fixing portion 31 of the optical sheet 30 and be inserted into the fixing recess 1215 of the sheet fixing recess 1210. The second hook 1155 disposed under the sheet fixing protrusion 1150 is inserted into the receiving recess 1215 to be hooked to a lower portion of the front supporting portion 1214.

Therefore, assembly of the backlight assembly 1500 may be completed.

The display panel 20 is disposed on the mold frame 1200 of the backlight assembly 1500.

The top chassis 10 is disposed on the backlight assembly 1500 on which the display panel 20 is disposed. The inner surface of the top chassis 10 may surround the outer surface of the mold frame 1200 to affix the mold frame 200.

For example, the screw may be fastened through the top chassis 10, the mold frame 1200 and the bottom chassis 50 from the side of the top chassis 10 so that the top chassis 10, the mold frame 1200 and the bottom chassis 50 may be assembled.

According to the exemplary embodiment, the sheet fixing member 1100 includes first hook 145 and the second hook 1155 to securely assemble the sheet 20 to the mold frame 1200.

FIG. 10 is a perspective view illustrating a sheet fixing recess 2210 according to an exemplary embodiment of the present inventive concept. A display apparatus including the sheet fixing recess of FIG. 10 is substantially the same as shown in FIGS. 1, 2, 3, 4, and 5 except the sheet fixing recess. Thus, any repetitive explanation concerning the same elements will be omitted.

Referring to FIGS. 1, 2 and 10, the sheet fixing recess 2210 includes a side supporting portion 211, an upper protrusion 212, a rear supporting portion 213, a front supporting portion 2214, a fixing hole 2215 and a horizontal supporting recess 217.

The side supporting portion 211 includes the horizontal supporting recess 217 to receive the horizontal protrusion 120 of a sheet fixing member 100.

The rear supporting portion 213 supports a vertical protrusion 140 of the sheet fixing member 100 to hook a first hook 145.

The front supporting portion 2214 is combined with the rear supporting portion 213 to form the fixing hole 2215. The fixing hole 2215 receives the sheet fixing protrusion 150 of the sheet fixing member 100.

The front supporting portion 2214 has substantially the same height as the rear supporting portion 213. When the front supporting portion 2214 has substantially the same height as the rear supporting portion 213, a peripheral portion of the optical sheet 30 may be supported by the front supporting portion 2214.

According to the exemplary embodiment, the peripheral portion of the optical sheet 30 is supported by the front supporting portion 2214 and the optical sheet 30 may have uniform height.

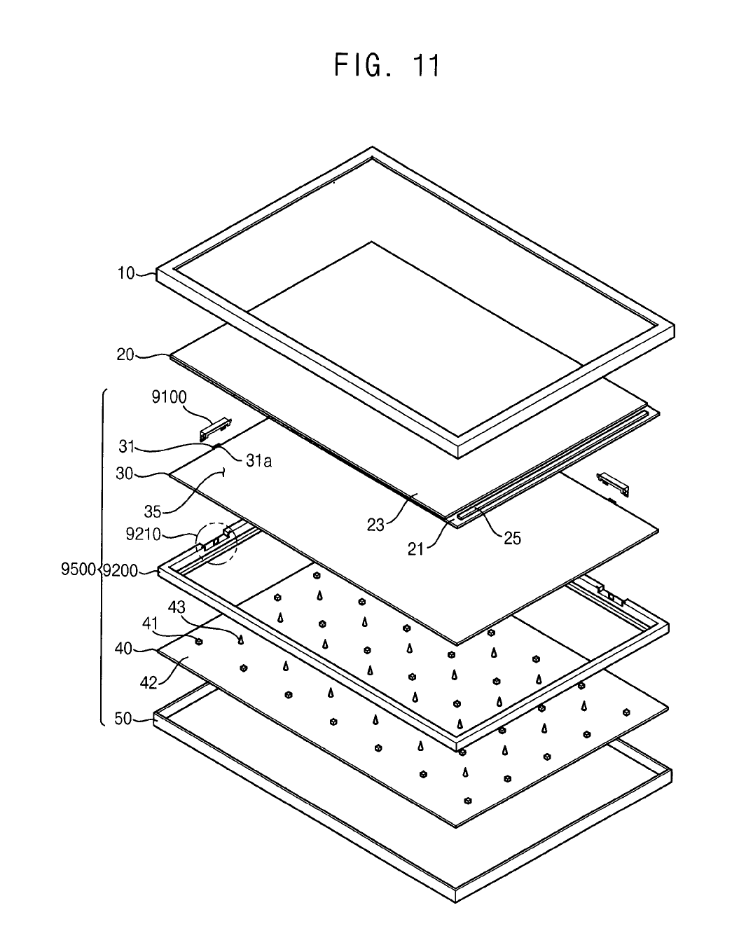

FIG. 11 is an exploded perspective view illustrating a display apparatus according to an exemplary embodiment of the present inventive concept. The display apparatus of FIG. 11 is substantially the same as shown in FIGS. 1, 2, 3, 4, and 5 except the sheet fixing member 9100 and the sheet fixing recess 9210. Thus, any further repetitive explanation concerning the same elements will be omitted.

Referring to FIG. 11, the display apparatus includes a display panel 20 and a backlight assembly 9500.

The backlight assembly 9500 is disposed under the display panel 20 to supply the display panel 20 with light and to support the display panel 20.

The backlight assembly 9500 includes a sheet fixing member 9100, an optical sheet 30, a mold frame 9200, a light source member 40 and a bottom chassis 50.

The light source member 40 is received in the bottom chassis 50 to generate the light.

The mold frame 9200 is combined with the bottom chassis 50 to receive the light source member 40.

A plurality of sheet fixing recesses 9210 is formed on a side surface of the mold frame 9200.

The optical sheet 30 is disposed on the mold frame 9200 to increase the uniformity of luminance of the light generated from the light source member 40.

The optical sheet 30 includes a sheet body 35 and a plurality of fixing portions 31 protruded from a side of the sheet body 35. The fixing portions 31 correspond to the sheet fixing recesses 1210, respectively. Each of the fixing portions 31 includes a through hole 31a.

The sheet fixing member 9100 is combined with the sheet fixing recess 9210 of the mold frame 9200 to affix the fixing portion 31 of the optical sheet 30.

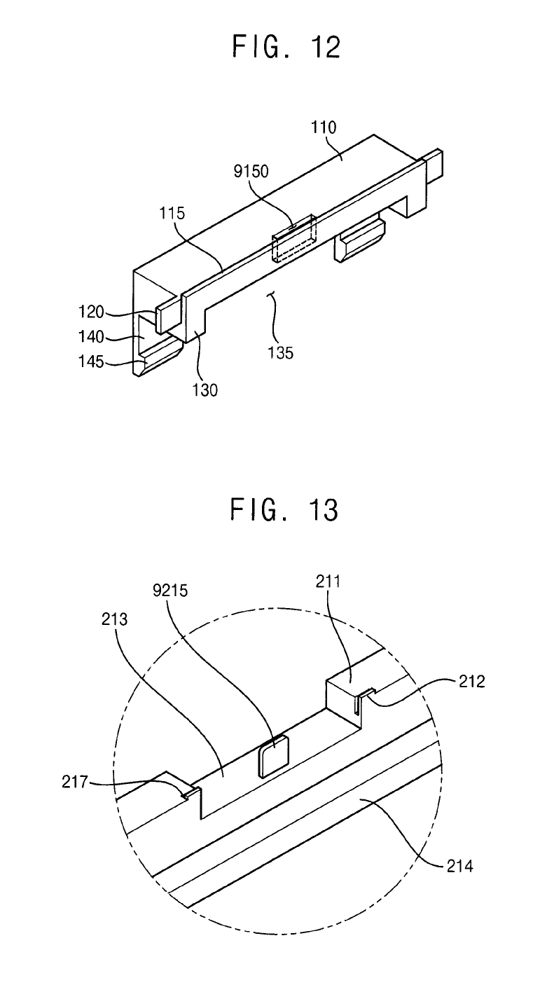

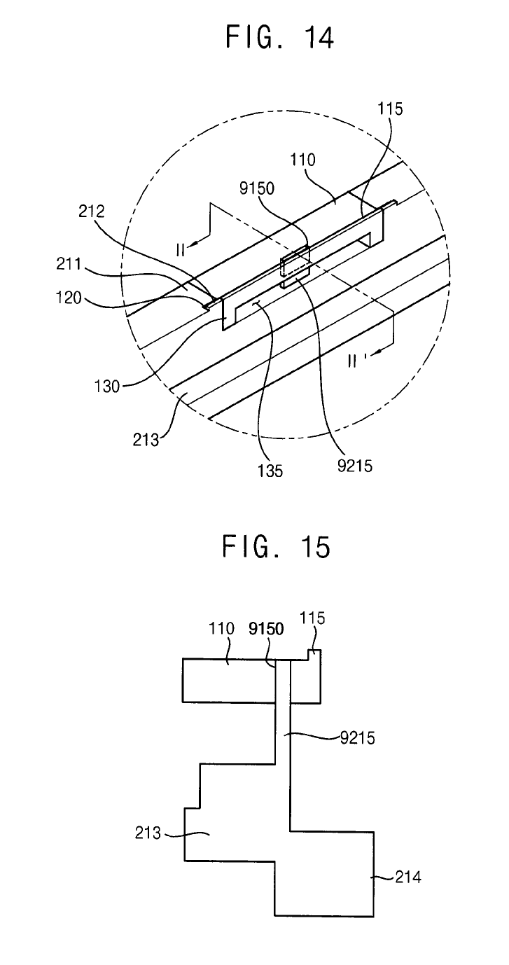

FIG. 12 is a perspective view illustrating a sheet fixing member 9100 of FIG. 11. FIG. 13 is a perspective view illustrating a sheet fixing recess 9210 of FIG. 11. FIG. 14 is a perspective view illustrating the combination between the sheet fixing member 9100 and the sheet fixing recess 9210 of FIG. 11. FIG. 15 is a cross-sectional view taken along a line II-IF of FIG. 14.

Referring to FIGS. 12, 13, 14, and 15, the sheet fixing member 9100 includes a body 110, a horizontal protrusion 120, a vertical leg 130, a vertical protrusion 140 and a sheet fixing protrusion 9150.

The body 110 is extended in a direction substantially parallel with the sidewall of the mold frame 9200.

The upper protrusion 115 of the sheet fixing member 9100 has substantially the same height as the upper protrusion 212 of the mold frame 9200. For example, the upper protrusions 115 and 212 make contact with an inner surface of the top chassis 10.

The horizontal protrusion 120 is protruded from the side surface of the body 110 to be inserted into a horizontal supporting recess 217 of the sheet fixing recess 9210.

The vertical leg 130 is protruded from both sides of a lower surface of the body 110 in a downward direction to form a sheet receiving space 135 in between the vertical legs 130 and the body 110. The sheet receiving space 135 receives the fixing portion 31 of the optical sheet 30.

The vertical protrusion 140 is protruded from the lower surface of the vertical leg 130 in the downward direction, and is arranged along an outer surface of the sheet fixing recess 9210. A first hook 145 is formed at a lower portion of the vertical protrusion 140 to be combined with the sheet fixing recess 9210.

The sheet fixing hole 9150 is vertically recessed into a central portion of a lower surface of the body 110.

The sheet fixing recess 9210 includes a side supporting portion 211, an upper protrusion 212, a rear supporting portion 213, a front supporting portion 214, a sheet fixing protrusion 9215 and a horizontal supporting recess 217.

The side supporting portion 211 includes a horizontal supporting recess 217 to receive the horizontal protrusion 120 of the sheet fixing member 9100.

The rear supporting portion 213 supports the vertical protrusion 140 of the sheet fixing member 9100 and hooks the first hook 145.

The front supporting portion 214 is combined with the rear supporting portion 213, which includes the sheet fixing protrusion 9215. The sheet fixing protrusion 9215 passes through the through hole 31a formed through the fixing portion 31 of the optical sheet 30 to be received in the fixing hole 9150 of the sheet fixing member 9100.

Therefore, assembly of the backlight assembly 9500 may be completed.

Referring back to FIG. 11, the display panel 20 is disposed on the backlight assembly 9500. More specifically, the display panel 20 may be disposed on the mold frame 9200 combined with the optical sheet 30 and the sheet fixing member 9100.

The top chassis 10 is combined with the backlight assembly 9500 to affix the display panel 20.

Referring to FIGS. 11, 12, 13, 14, and 15, a method of fabricating the display apparatus of the exemplary embodiment will be explained as follows.

The bottom chassis 50 is disposed with its aligned upward.

The light source member 40 is disposed in the bottom chassis 50.

The mold frame 200 is assembled with the bottom chassis 50.

The optical sheet 30 is disposed on the mold frame 9200 with the fixing portion 31 disposed in the sheet fixing recess 9210 of the mold frame 9200. The sheet fixing protrusion 9215 passes through the through hole 31a of the fixing portion 31 of the optical sheet 30, into the fixing hole 9150.

The sheet fixing member 9100 may be assembled with the sheet fixing recess 9210 to affix the optical sheet 30 with the mold frame 9200. The horizontal protrusion 120 of the sheet fixing member 9100 is inserted into the horizontal supporting recess 217 of the sheet fixing recess 9210, and the vertical protrusion 140 is combined along the outer surface of the rear supporting portion 213 of the sheet fixing recess 9210. The first hook 145 formed under the vertical protrusion 140 is hooked under the outer surface of the rear supporting portion 213. The sheet fixing protrusion 9215 may be passed through the fixing hole 31a of the fixing portion 31 of the optical sheet 30 and be inserted into the fixing recess 9150 of the sheet fixing member 9100.

Therefore, assembly of the backlight assembly 9500 may be completed.

The display panel 20 is disposed on the mold frame 9200 of the backlight assembly 9500.

The top chassis 10 is disposed on the backlight assembly 9500 on which the display panel 20 is disposed.

For example, the screw may be fastened through the top chassis 10, the mold frame 9200 and the bottom chassis 50 from the side of the top chassis 10 so that the top chassis 10, the mold frame 9200 and the bottom chassis 50 may be assembled.

According to the exemplary embodiment, the optical sheet 30 affixed by the mold frame 9200 is combined with the sheet fixing member 9100. Thus, the display apparatus may be easily fabricated.

According to the example embodiments of the present inventive concept, the sheet fixing member includes the sheet fixing protrusion that passes through the optical sheet to be assembled with the mold frame. Thus, the optical sheet may be securely assembled with the mold frame. Also, additional fixing tape may be omitted so that the manufacturing process may be simplified and the manufacturing cost may be decreased. In The sheet fixing member may include the first hook and the second hook to securely fix the sheet to the mold frame. Furthermore, the peripheral portion of the optical sheet may be supported by the front supporting portion so that the optical sheet may have uniform height. Also, the optical sheet affixed by the mold frame may be combined with the sheet fixing member. Thus, the display apparatus may be easily fabricated. The sheet fixing member may also include the upper protrusion so that the mold frame and the sheet fixing member may be securely combined with the top chassis.

In the present inventive concept, the sheet fixing member may be substituted by various elements such as a guide sheet, a fixing pin, a clip, etc.

The foregoing is illustrative of the present teachings and is not to be construed as limiting thereof. Although a few exemplary embodiments have been described, those skilled in the art will readily appreciate from the foregoing that many modifications are possible in the exemplary embodiments without materially departing from the novel teachings and advantages of the present disclosure of inventive concept. Accordingly, all such modifications are intended to be included within the scope of the present teachings. In the claims, means-plus-function clauses are intended to cover the structures described herein as performing the recited function and not only structural equivalents but also functionally equivalent structures.

What is claimed is:

1. A sheet fixing member, comprising:
a body extended substantially parallel with the sidewall;
a horizontal protrusion protruded from a side of the body configured to be inserted into the horizontal supporting recess;
a vertical leg disposed at each side of a lower surface of the body to extend in a downward direction, the vertical legs and the body forming a sheet receiving space therebetween; and
a sheet fixing protrusion protruded from a center of the lower surface of the body in the downward direction, the sheet fixing protrusion configured to be passed through the optical sheet disposed in the sheet receiving space and to be inserted into the fixing hole,
wherein the sheet fixing member is configured to be combined with a sheet fixing recess formed on a sidewall of a mold frame to affix an optical sheet, the sheet fixing recess comprising a horizontal supporting recess extended substantially parallel with the sidewall and a fixing hole formed substantially perpendicular to the sidewall.

2. The sheet fixing member of claim 1, further comprising:
a vertical protrusion protruded from a lower surface of the vertical leg in the downward direction; and
a first hook formed on a lower portion of the vertical protrusion configured to be hooked onto the sheet fixing recess.

3. The sheet fixing member of claim 2, wherein the sheet fixing protrusion comprises a second hook configured to be inserted into the fixing hole and to be hooked onto the sheet fixing recess.

4. The sheet fixing member of claim 1, further comprising an upper protrusion protruded from the body.

5. A backlight assembly, comprising:
a light source member configured to generate light;
a bottom chassis configured to affix the light source member;
a mold frame disposed on the bottom chassis, the mold frame comprising a sheet fixing recess formed on a sidewall of the mold frame;
an optical sheet comprising:
a sheet body; and
a fixing portion being protruded from a side of the sheet body aligned to the sheet fixing recess,
wherein the optical sheet is disposed on the mold frame; and
a sheet fixing member combined with the sheet fixing recess, the sheet fixing member comprising:
a body extending substantially parallel with the sidewall;
a vertical leg disposed at each side of a lower surface of the body to extend in a downward direction, the vertical legs and the body forming a sheet receiving space therebetween, in which the fixing portion is received; and
a sheet fixing protrusion protruded from a center of the lower surface of the body in the downward direction, the sheet fixing protrusion configured to be passed through the fixing portion of the optical sheet and to be inserted into a fixing hole formed in the fixing recess.

6. The backlight assembly of claim 5, wherein the sheet fixing member further comprises a horizontal protrusion protruded from a side of the body, and
the sheet fixing recess further comprises a horizontal supporting recess,
wherein the horizontal protrusion is configured to be inserted into the horizontal supporting recess.

7. The backlight assembly of claim 5, wherein the sheet fixing member further comprises a vertical protrusion protruded from a lower surface of the vertical leg in the downward direction and a first hook formed on a lower portion of the vertical protrusion, and
the sheet fixing recess further comprises a rear supporting portion configured to support the vertical protrusion.

8. The backlight assembly of claim 7, wherein the sheet fixing protrusion comprises a second hook configured to be inserted into the fixing hole of the sheet fixing recess and to be hooked onto the sheet fixing recess.

9. The backlight assembly of claim 7, wherein the sheet fixing recess further comprises a front supporting portion assembled with the rear supporting portion to form the fixing hole, and the front supporting portion has lower height than the rear supporting portion.

10. The backlight assembly of claim 7, wherein the sheet fixing recess further comprises a front supporting portion assembled with the rear supporting portion to form the fixing hole, and the front supporting portion has substantially the same height as the rear supporting portion to support a peripheral portion of the optical sheet.

11. The backlight assembly of claim 5, wherein the sheet fixing member further comprises an upper protrusion protruded from the body, and the mold frame further comprises an upper protrusion having substantially the same height as the upper protrusion of the sheet fixing member.

12. The backlight assembly of claim 5, wherein the optical member further comprises a sheet supporting portion that is configured to support a central portion of the optical sheet.

13. The backlight assembly of claim 5, wherein the mold frame comprises a plurality of sheet fixing recesses, the backlight assembly comprises a plurality of sheet fixing members, and the optical sheet comprises a plurality of fixing portions corresponding to the plurality of sheet fixing recesses.

14. The backlight assembly of claim 13, wherein the plurality of sheet fixing recesses is formed on only two adjacent sidewalls among four sidewalls of the mold frame.

15. A backlight assembly, comprising:
a light source member configured to generate light;
a bottom chassis configured to affix the light source member;
a mold frame disposed on the bottom chassis, the mold frame comprising a sheet fixing recess formed on a sidewall of the mold frame;
an optical sheet comprising:
a sheet body; and
a fixing portion being protruded from a side of the sheet body aligned to the sheet fixing recess,
wherein the optical sheet is disposed on the mold frame; and
a sheet fixing member combined with the sheet fixing recess, the sheet fixing member comprising:
a body extending substantially parallel with the sidewall;
a vertical leg disposed at each side of a lower surface of the body to extend in a downward direction, the vertical legs and the body forming a sheet receiving space therebetween, in which the fixing portion is received; and
a sheet fixing protrusion protruded from a center of the lower surface of the body in the downward direction, the sheet fixing protrusion configured to be passed through the fixing portion of the optical sheet and to be inserted into a fixing hole formed in the fixing recess.

16. The backlight assembly of claim 15, wherein the sheet fixing member further comprises a horizontal protrusion protruded from a side of the body, and
the sheet fixing recess further comprises a horizontal supporting recess,
wherein the horizontal protrusion is configured to be inserted into the horizontal supporting recess.

17. The backlight assembly of claim 15, wherein the sheet fixing member further comprises a vertical protrusion protruded from a lower surface of the vertical leg in a downward direction and a first hook formed on a lower portion of the vertical protrusion configured to be hooked in the sheet fixing recess, and
the sheet fixing recess further comprises a rear supporting portion configured to support the vertical protrusion.

18. A display apparatus, comprising:
a backlight assembly comprising:
a light source member configured to generate light;
a bottom chassis configured to affix the light source member;
a mold frame disposed on the bottom chassis, the mold frame comprising a sheet fixing recess formed on a sidewall of the mold frame;
an optical sheet comprising:
a sheet body; and
a fixing portion being protruded from a side of the sheet body aligned to the sheet fixing recess,
wherein the optical sheet is disposed on the mold frame; and
a sheet fixing member combined with the sheet fixing recess, comprising:
a body extending substantially parallel with the sidewall;
a vertical leg disposed at each side of a lower surface of the body to extend in a downward direction, the vertical legs and the body forming a sheet receiving space therebetween, in which the fixing portion is received; and
a sheet fixing protrusion protruded from a center of the lower surface of the body in the downward direction, the sheet fixing protrusion configured to be passed through the fixing portion of the optical sheet and to be inserted into a fixing hole formed in the fixing recess;
a display panel disposed on the backlight assembly to display an image using the light from the light source member; and
a top chassis disposed on the display panel to affix the display panel to the backlight assembly.

19. The display apparatus of claim 18, wherein the sheet fixing member further comprises a horizontal protrusion protruded from a side of the body, and
the sheet fixing recess further comprises a horizontal supporting recess,
wherein the horizontal protrusion is configured to be inserted into the horizontal supporting recess.

20. The display apparatus of claim 18, wherein the sheet fixing member further comprises a vertical protrusion protruded from a lower surface of the vertical leg in a downward direction and a first hook formed on a lower portion of the vertical leg configured to be hooked in the sheet fixing recess,
the sheet fixing recess further comprises a rear supporting portion configured to support the vertical protrusion, and
the sheet fixing protrusion further comprises a second hook configured to be inserted into the fixing hole of the sheet fixing recess and to be hooked onto the sheet fixing recess.
